(19) United States
(12) Patent Application Publication
(10) Pub. No.: US 2019/0089899 A1
(43) Pub. Date: Mar. 21, 2019

(54) IMAGE PROCESSING DEVICE

(71) Applicant: SONY INTERACTIVE ENTERTAINMENT INC., TOKYO (JP)

(72) Inventors: Yasuhiro WATARI, TOKYO (JP); Takayuki ISHIDA, TOKYO (JP); Akira SUZUKI, TOKYO (JP)

(21) Appl. No.: 16/083,239

(22) PCT Filed: Feb. 9, 2017
(86) PCT No.: PCT/JP2017/004760

§ 371 Date: Sep. 7, 2018

(30) Foreign Application Priority Data
Mar. 23, 2016 (JP) 2016-058694

(51) Int. Cl. H04N 5/232; G02B 27/01; G03B 37/02; G06T 3/40

(52) U.S. Cl. CPC H04N 5/23238; G06T 3/4038; G03B 37/02; G02B 27/0172

(57) ABSTRACT

Disclosed herein is an image processing device to be connected to a display device which is worn on the user's head during operation, that determines a position of an object to be photographed outside coverage of a camera attached to the display device, and that controls the display device as to display a guide image that guides the user to a position where the camera can photograph the object position.

### TECHNICAL FIELD

The present invention relates to an image processing device, a method for image processing, and a program, the device displaying videos on a display device which is worn on the user's head during operation.

### BACKGROUND ART

There is known a display device, such as head mounted display, to be worn on the user's head. This display device is so designed as to form images in front of the user's eyes for the user to view such images. There is also known a technique which has recently been proposed to provide the foregoing display device with a camera to photograph images surrounding the user. The images taken by such a camera permit the user to realize the structure of the user's room or the like, and they function as the image which the user views.

### SUMMARY

### Technical Problem

The foregoing technology has a disadvantage that the user needs to move his or her head when he wants to photograph any place outside the camera's coverage or any object behind something, so that the camera covers the object or place which he wants to photograph. Unfortunately, the user may not fulfill his need because he does not necessarily grasp the coverage of the camera.

The present invention has been completed in view of the foregoing. Its object is to provide an image processing device, an image processing method, and a program, the device permitting the user to easily photograph his surroundings with a camera attached to a display device or head-wearing type.

### Solution to Problem

An image processing device pertaining to the present invention is one to be connected to a display device which is worn oh the user's head during operation. The image processing device includes an object position determining unit configured to determine a position of an object to be photographed outside coverage of a camera attached to the display device, and a display controlling unit configured to control the display device so as to display a guide image that guides the user to a position where the camera can photograph the object position.

An image processing method pertaining to the present invention is one for displaying images on a display device to be worn on the user's head during operation. The method includes a step of determining a position of an object to be photographed outside coverage of a camera attached to the display device and a step of controlling the display device so as to display a guide image that guides the user to a position where the camera can photograph the object position.

A program pertaining to the present inventions is one to display images on a display device worn on the user's head during operation. The program causes a computer to function as an object position determining unit configured to determine a position of an object to be photographed outside coverage of a camera attached to the display device, and a display controlling unit configured to control the display device so as to display a guide image that guides the user to a position where the camera can photograph the object position. This program can be stored and provided from any non-temporary computer-readable memory medium.

### BRIEF DESCRIPTION OF DRAWINGS

FIG. 1 is a block diagram depicting an entire structure of a video display system which includes an image processing device pertaining to one embodiment of the present invention.

FIG. 2 is a diagram depicting one example of a display device to be worn on the user's head.

FIG. 3 is a block diagram depicting a function to be achieved by the image processing unit pertaining to the embodiment of the present invention.

FIG. 4 is a diagram depicting one example of a guide image.

FIG. 5 is a diagram depicting another example of the guide image.

### DESCRIPTION OF EMBODIMENT

The following is a detailed description of the embodiment of the present invention which is given with reference to the accompanying drawings.

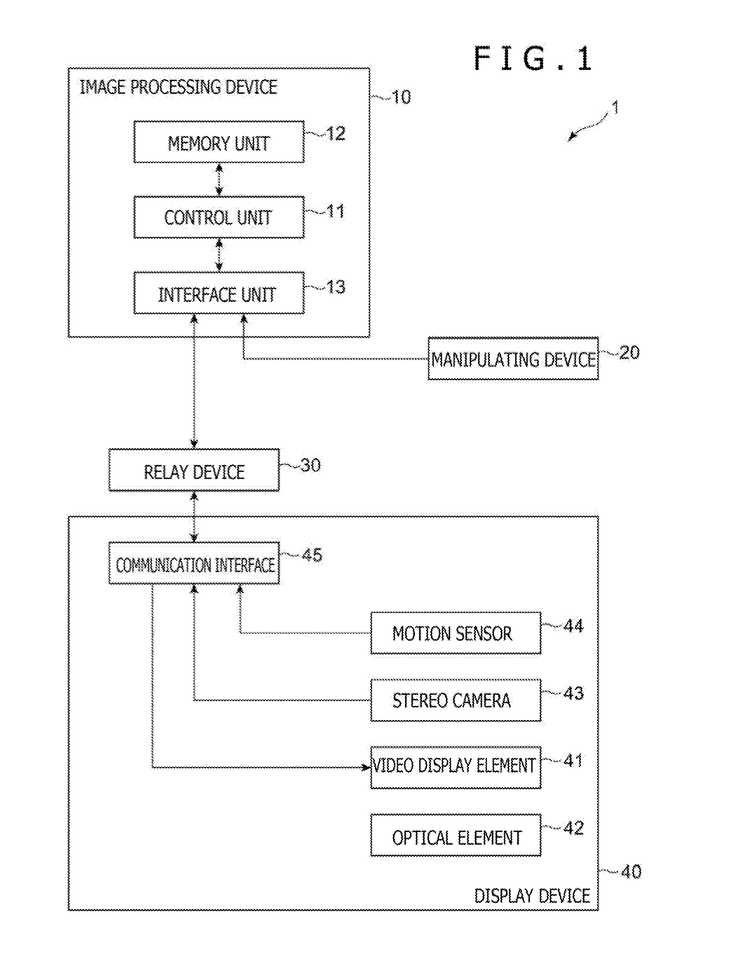

One embodiment of the present invention covers an image processing device 10 included in a video display system 1 which is constructed as depicted by a block, diagram in FIG. 1. As depicted in FIG. 1, the video display system 1 includes the image processing device 10, a manipulating device 20, a relay device 30, and a display device 40.

The image processing device 10 is a device that generates and supplies the image to be displayed on the display device 40. It includes, for example, home game machine, portable game machine, personal computer, smart phone, and tablet. As depicted in FIG. 1, the image processing device 10 includes a control unit 11, a memory unit 12, and an interface unit 13.

The control unit 11 contains at least one processor such as central processing unit (CPU), so that it executes various kinds of information processing by means of the program stored in the memory unit 12. Incidentally, the typical examples of processing to be performed by the control unit 11 will be illustrated in the embodiment of the present invention that follows. The memory unit 12 contains at least one memory device such as random access memory (RAM), so that it stores a program to be executed by the control unit 11 and the data to be processed by the program.

The interface unit 13 makes data communication possible between the manipulating device 20 and the relay device 30. The image processing device 10 is connected to the manipulating device 20 and the relay device 30 through the interface unit 13 by means of wire or wireless circuit. To be more concrete, the interface unit 13 may contain a multimedia interface such as high definition multimedia interface (HDMI, registered trademark), so that it transmits video and audio signals from the image processing device 10 to the relay device 30. Also, the interface unit 13 contains a data communication interface such as Bluetooth (registered trademark) and universal serial bus (USB). This data communication interface helps the image processing device 10 to receive various kinds of information from the display device 40 through the relay device 30 and transmit control signals. The data communication interface also permits manipulating signals to be received from the manipulating device 20.

The manipulating device 20 is a controller or keyboard for a home game machine; it receives the user's instructions for operation. The manipulating device 20 also transmits to the image processing device 10 the signals representing the input given by the user. The relay device 30 is connected to the display device 10 by means of wire or wireless circuit, so that it receives image data supplied from the image processing device 10 and transmits the received data to the display device 40. This step may be accomplished according to need in such a way that the relay device 30 performs correction on the supplied image data to eliminate distortion resulting from the optical system of the display unit 40 and subsequently outputs the corrected image data. Incidentally, the image data supplied from the relay device 30 to the display device 40 contains the frame image to be used as the image for the left eye and the image for the right eye. In addition, the relay device 30 relays various kinds of information, such as audio data and control signals in addition to image data, which are communicated between the image processing device 10 and the display device 40.

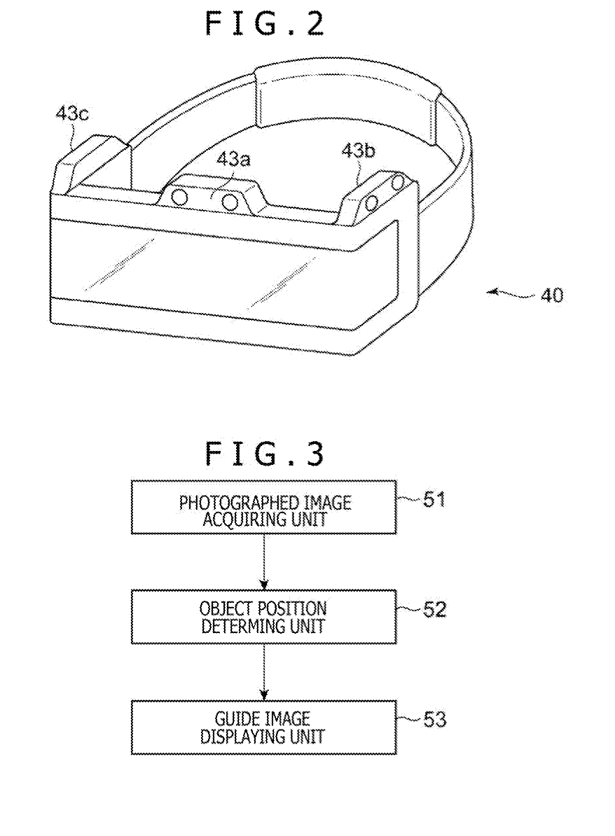

The display device 40 displays the video corresponding to the image data received from the relay device 30, so that the user can view the image. According to this embodiment, the display device 40 is so designed as to be worn on the user's head, and it is also designed such that the user views the video with both eyes. In other words, the display device 40 produces videos in front of the user's right eye end left eye. In this way, the display device 40 is able to display stereoscopic images with the help of binocular parallax. As depicted in FIG. 1, the display device 40 includes a video display element 41, an optical element 42, a stereo camera (one or more) 43, a motion sensor 44, and a communication interface 45. The display device 40 has an exemplary external appearance as depicted in FIG. 2.

The video display element 41 is an organic electroluminescence (EL) display panel or a liquid crystal display panel, which displays videos in response to the video signals supplied form the relay device 30. The video display element 41 displays two videos: one for the left eye and the other for the right eye. Incidentally, the video display element 41 may be of single type capable of displaying two videos side by side for the right and left eyes; or it may be of dual type capable of displaying two videos independently from each other. Moreover, it may be any known video display element 41 such as smart phone. In addition, the display device 40 may be of that type capable of projecting videos directly to the user's retina. In this case, the video display element 41 may include a laser unit (emitting light) and a micro electro mechanical systems (MEMS) mirror to scan the laser beam.

The optical element 42 is a hologram, a prism, or a half mirror. It is arranged in front of the user's eyes, so that it passes or refracts the light of the video produced by the video display element 41, thereby causing the light to impinge on the user's right and left eyes. To be more concrete, the video for the left eye which is displayed by the video display element 41 passes through the optical element 42 and impinges on the user's left eye, and the video for the right eye passes through the optical element 42 and impinges on the user's right eye. As the result, the user is able to view the right and left videos with his right and loft eyes, respectively, while he is wearing the display device 40 on his head.

The stereo camera 43 includes a plurality of cameras arranged side by side. The display device 40 according to this embodiment depicted in FIG. 2 is provided with three sets of stereo cameras 43a to 43c. These stereo cameras 43 ere so arranged as to point to the front, right, and left of the display device 40. The stereo cameras 43 have their images transmitted to the image processing device 10 through the relay device 30. The image processing device 10 determines the parallax of the subject photographed by each unit of the stereo camera 43, thereby calculating the distance to the subject. In this way, the image processing device 10 creates the depth map representing the distance to objects around the user.

The motion center 44 collects all sorts of information about the position, direction, and movement of the display device 40. It may contain an acceleration sensor, gyroscope, geomagnetism sensor, etc. The information collected by the motion sensor 44 is transmitted to the image processing device 10 through the relay device 30. The image processing device 10 utilizes the information collected by the motion sensor 44 in order to determine how the display device 40 has changed in movement and direction. To be more concrete, the image processing device 10 is able to detect how much the display device 40 has inclined (with respect to the vertical line) and undergone parallel displacement, with the help of information collected by the acceleration sensor. Also, the collected information by the gyroscope and geomagnetism sensor help detect the rotation of the display device 40. Moreover, in order to detect the movement of the display device 40, the image processing device 10 may utilize the image taken by the stereo camera 43 as well as the information collected by the motion sensor 44. To be more concrete, it is possible to determine the change of the direction and position of the display device 40 by knowing how the subject and background in the photographed image move and change.

The communication interface 45 is intended for data communication with the relay device 30. It includes an antenna and module for data communication (through wireless local area network (LAN) or Bluetooth) between the display device 40 and the relay device 30. It may also include such communication interface as HDMI and USB for wired data communication with the relay device 30.

The image processing device 10 performs the function which is described below with reference to FIG. 3. As depicted in FIG. 3, it includes a photographed image acquiring unit 51, an object position determining unit 52, and a guide image displaying unit 53. They fulfill their functions as the control unit 11 executes one or more programs stored in the memory unit 12. This program may be one which is provided to the image processing device 10 through communication networks (such as the Internet) or from a computer-readable recording medium (such as optical disk).

The photographed image acquiring unit 51 acquires from the display device 40 the images photographed by the stereo camera 43. It utilizes the thus acquired image to create the depth map which indicates the distance to the objects around the display device 40. Since the display unit 40 according to this embodiment is provided with three sets of stereo cameras 43 as mentioned above, the images photographed by these stereo cameras 43 permit the photographed image acquiring unit 51 to create the depth map that covers the ranges extending forward, rightward, and leftward. With the help of this depth map, the image processing device 10 is able to define the spatial information, which relates to the shape of objects existing around the user, the distance to the walls surrounding the display device 40, and the structure of the room accommodating the user.

The object position determining unit 52 determines the position fox the spatial information to be additionally acquired by the photographed image acquiring unit 51 after it has acquired the photographed images. The term “object position” used below denotes the object for which the additional spatial information is to be acquired. The object position determining unit 52 defines the position to be additionally photographed which is outside the photographing range of the stereo camera 43. Such a position is one which is blocked by a masking object existing in the room or which is in the blind spot (behind the user) of the three sets of stereo cameras 43. The depth map cannot be formed for these positions when the user starts using the display device 40 worn on his head.

The object position determining unit 52 may be realized by any application program to execute the process (such as game). In this case, it assigns as the object position the region which cannot be photographed by the stereo camera 43, the object position being selected from the region necessary for its processing.

To be more concrete, it is possible to define the object position according to the direction pointed from the position where the display device 40 currently exists. In this case, the object position may be regarded as the position on a hypothetical sphere with its center placed at the present position of the display device 40, and such a position may be represented by the polar coordinates defined by the azimuth and the elevation angle.

Also, the object position may be one which is defined by the position coordinates within the real space in which the display device 40 exists. The display device 40 may have its initial position regarded as the origin of the coordinate system which defines the region, such as one behind the masking object viewed from the user, which cannot be defined by only the direction extending from the display device 40.

The guide image displaying unit 53 causes the display device 40 to display the guide image, which permits the user to be guided from the object position determined by the object position determining unit 52 to the position that can be photographed by the stereo camera 43. This is explained below more concretely. When the user utilizes the stereo camera 43 to photograph the object position, with the display device 40 worn on his head, he needs to move his head so that the object position is contained in the coverage of any one of the stereo cameras 43. It is desirable for the user to move his head as slightly as possible so that the object position is contained in any one of the stereo cameras 43. For the user, to achieve this object naturally with his minimum action, the guide image displaying unit 53 generates the guide image and transmits it to the display device 40. The display device 40 presents the guide image to the user, thereby allowing him to perform an action for photographing the object position.

It is assumed that the guide image displaying unit 53 causes the guide images displayed or the display device 40 to change in their content according to the movement of the user's head. To be more concrete, the guide image displaying unit 53 has a virtual three-dimensional space in which it arranges the guide object and the view point and produces the image (for display) that indicates how the guide object seen from the view point looks like. Then it changes the position of the view point and the direction of the sight line in the virtual three-dimensional space according to the change in the position and direction of the user's face based on the results of detection by the motion sensor 44 and on the images photographed by the stereo camera 43. As the result, the user can view the images that change in response to the movement of his face. Thus, the user changes the position and direction of his face according to the position of the guide object in the virtual three-dimensional space, so that the stereo camera 43 attached to the display device 40 can photograph the object position in the real space.

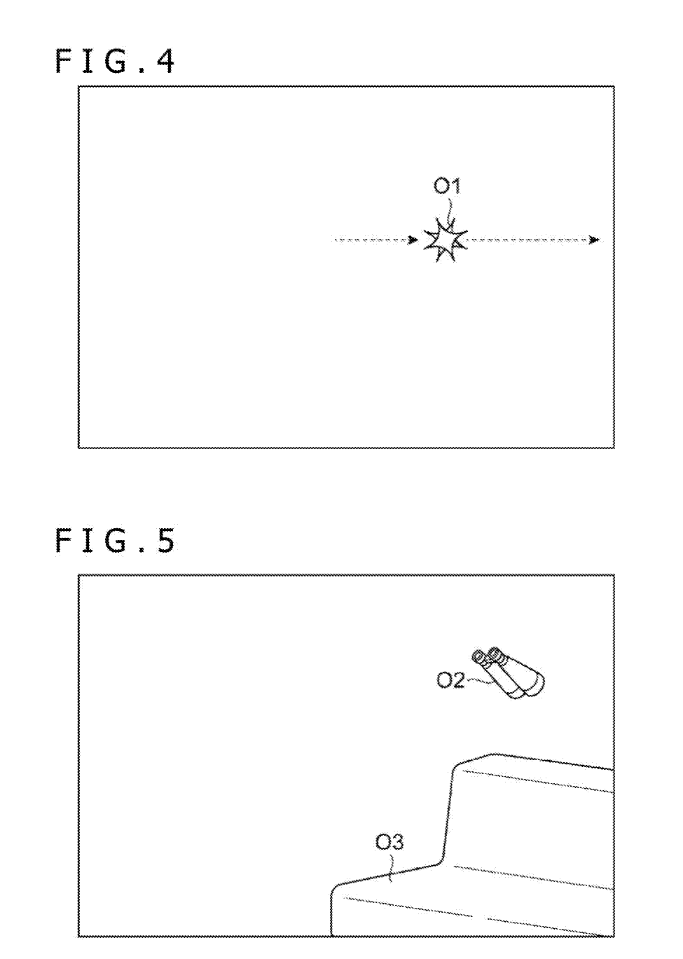

The foregoing is explained below more concretely. In the case where the object position is specified by the direction in which it is viewed from the user's present position, the guide image may be on imago to change the direction of the user's sight line. In this case, an example of the guide image looks like as depicted in FIG. 4. The illustrated guide image tells the user the direction (target direction) into which the user should turn his sight line. In the case of this illustration, a guide object O1 to attract the user's attention appears in front of the user and it moves toward the target as indicated by the broken-line arrow as depicted. As the user follows the guide object O1 with his eyes and turns his face toward the object direction, the stereo camera 43 changes the photographing direction so that it covers the object position. In this case, the guide object O1 may be any one which attracts the user's attention; for example, it may be a character object imitating a human.

Incidentally, in the case illustrated above, the user does not necessarily need to move his sight line to the direction of the object position. The user merely needs to turn rightward if the object position is behind the user, and the stereo camera 43c, which is arranged or the right side of the display device 40, is turned to the hack of the user. For this purpose, the guide image displaying unit 53 calculates the direction to which the user should turn in order that any one of the stereo cameras 43 covers the object position, and it determines the direction of the target in this way. At this time, the direction of the target should desirably be determined by the guide image displaying unit 53 such that the user turns his face as little as possible. Finally, the guide image displaying unit 53 displays the guide image that leads the user's sight line to the thus determined target direction.

The guide image displaying unit 53 may also display the guide images (around the user) which permits the user to discriminate between the direction which has been photographed by the stereo camera 43 and the direction which has not been photographed by the stereo camera 43 (or the direction which has been defined as the object position). To be more concrete, the guide image displaying unit 53 arranges a hemisphere (with its center at the eye point position) as a guide object in the virtual three-dimensional space. Then, it attaches textures (differing from each other) to the region, which has been photographed by the stereo camera 43, and the region, which has not been photographed by the stereo camera 43, inside the virtual hemisphere. In addition, the guide image displaying unit 53 displays the guide image that represents the hemisphere's inside as viewed from the eye point position. This permits the user to recognize the object position which the stereo camera 43 cannot easily photograph around the user. Incidentally, the texture to be attached to the region which has been photographed may be one which represents the content of the photographed image. In this way, the user is given the image representing the real state of the room for the region which has been photographed.

Meanwhile, the foregoing procedure is not satisfactory in that the stereo camera 43 can photograph the object position when the user simply turns his face in the case where the object position is in the region hidden by a masking object. To cope with this situation, the guide image displaying unit 53 displays the guide image that helps the user change his face position as well as his face direction. The guide image in this case will guide the user to the object position (to which the user moves his face in the real space) and the target direction (in which the user turns his face from the position). An example of the guide images is depicted in FIG. 5, in which the guide image displaying unit 53 displays the guide image which contains a guide object O2 imitating a binocular, which is arranged at a specific position and in a specific direction in the virtual three-dimensional space. This guide object O2 urges the user to move his face to the position and to change the direction of his face so that he looks through the binocular. This permits the stereo camera 43 to photograph the object position which is hidden by the masking object. Incidentally, FIG. 5 depicts a masking object O3 in addition to the guide object O2. The masking object O3 represents the position and approximate shape of the real masking object. It is generated in response to the space information generated by the photographed image acquiring unit 51 and it is arranged, together with the guide object O2, in the virtual space.

In the illustrated case, the user does not need to move his sight line directly to the direction of the object position. To be more concrete, the guide image displaying unit 53 determines the target position and the target direction so that any one of the stereo cameras 43 covers the object position excluding the masking, object, with the acquired space information taken into consideration. Further, it displays the guide imago to guide the position and direction of the user's face toward the target position and target direction which have been determined. FIG. 5 depicts a guide image displayed by the guide image displaying unit 53. This guide image has the guide object O2 arranged at the position in the virtual space (which is determined according to the target position) and also arranged in the direction (which is determined according to the target direction).

Alternatively, the guide image displaying unit 53 may display the guide object that makes the user want to go away, thereby guiding the movement of the user's head. For example, it may display a guide image that represents as if something comes flying toward the user, so that the user naturally moves his head to avoid the flying object. This causes the user to change unconsciously the coverage of the stereo camera 43.

Also, the guide image may illustrate the state of the virtual space having the light source therein arranged at the target position or in the target direction so as to let the user know the target position and target direction. The guide image representing the light emanating from the light source may tell the user the direction in which he should direct his sight line even though the target position and target direction are outside the region displayed in the guide image or in the region hidden by masking object.

The guide image displaying unit 53 may be provided with a function to reproduce a sound that guides the user's sight line when it displays the guide image. For this purpose, the image processing device 10 is assumed to be connected to an audio system, such as speaker and earphone, capable of reproducing sounds in stereo or surround mode. The audio system reproduces sounds as if the sound source exists in the direction in which the guide image displaying unit 53 wants to guide the user's sight line. This makes it easy to guide the user's sight line.

After the guide image displaying unit 53 has displayed the guide image to guide the user's sight line, the photographed image acquiring unit 51 acquires the image, of the object position which was photographed by the stereo camera 43. This allows the user to acquire the space information of the object position which has not been acquired until then and to utilize it for processing game or the like. Incidentally, there will be an instance in which any ono of the stereo cameras 43 photographs the object position after the other stereo cameras 43 have already finished photographing the images necessary to generate the space information. In this case, it is acceptable that the other stereo cameras 43 photograph under the different condition for the stereo camera 43 that photographs the object position at the same time. For example, the other stereo cameras 43 may perform photographing with a reduced exposure in order to estimate the light source, or in order to generate the distance image by changing the distance range to be noted when the distance image is generated. This makes it possible to acquire the information around the display device 40 by effectively utilizing the stereo camera 43.

The foregoing has demonstrated that the image processing device 10 pertaining to this embodiment gives a guide display that instructs the user to move the position and direction of his face so that the stereo camera 43 can photograph the object position. This helps the user take actions necessary for photographing in a natural way.

Incidentally, the foregoing description is not intended to restrict the scope of the embodiment according to the present invention. For example, although it is assumed that the display device 40 mentioned above has three sets of stereo cameras 43, it may have only one set or two sets or four or more sets of the stereo cameras 43. Moreover, the display device 40 may be provided with a variety of cameras in addition to the stereo cameras. In this case, too, the display device 40 gives a guide display to guide the user so that the camera can photograph the specific position around the display device 40.

It is assumed in the foregoing that the image processing device 10 and the display device 40 are connected to each other through the relay device 30. The direct connection between the image processing device 10 and the display device 40 is possible notwithstanding the embodiment mentioned above.

### REFERENCE SIGNS LIST

1 Video display system
10 Image processing device
11 Control unit
12 Memory unit
13 Interface unit
30 Relay device
40 Display device
41 Video display element
42 Optical element
43 Stereo camera
44 Motion sensor
45 Communication interface
51 Photographed image acquiring unit
52 Object position determining unit
53 Guide image displaying unit

1. An image processing device to be connected to a display device which is worn on the user's head during operation, said image processing device comprising:
an object position determining unit configured to determine a position of an object to be photographed outside coverage of a camera attached to said display device; and
a display controlling unit configured to control said display device so as to display a guide image that guides said user to a position where said camera can photograph said object position.

2. The image processing device according to claim 1, wherein said object position is a position specified in a direction as seen from said display device, and
said guide image guides a direction of the user's face to a target direction in which said camera can photograph said object position.

3. The image processing device according to claim 2, wherein said guide image is an image which represents how a given guide object moves toward said target direction from the front of said user.

4. The image processing device according to claim 1, wherein said object position is one which is represented by position coordinates in a real space, and said guide image is one which guides a position of the user's face to a target position in the real space in which said camera can photograph said object position and also guides a direction of the user's face in a target direction as seen from said target position.

5. The image processing device according to claim 4, wherein said guide image is one which represents a guide object arranged in a direction corresponding to said target direction at a position in a virtual space corresponding to said target position.

6. An image processing method for displaying images on a display device to be worn on the user's head during operation, said method comprising:
determining a position of an object to be photographed outside coverage of a camera attached to the display device; and
controlling said display device so as to display a guide image that guides said user to a position where said camera can photograph said object position.

7. A program to display images on a display device worn on the user's head during operation, said program for a computer, comprising:
by an object position determining unit, determining a position of an object to be photographed outside coverage of a camera attached to said display device; and
by a display controlling unit, controlling said display device so as to display a guide image that guides said user to a position where said camera can photograph said object position.
